(19) United States
(12) Patent Application Publication
(10) Pub. No.: US 2025/0192336 A1
(43) Pub. Date: Jun. 12, 2025

(54) BATTERY PACK THERMAL BARRIERS THAT HOLD A CELL FOLD

(71) Applicant: Ford Global Technologies, LLC, Dearborn, MI (US)

(72) Inventors: Antony George Schepak, Howell, MI (US); Deanna Marie Winton Hoffman, Ann Arbor, MI (US)

(21) Appl. No.: 18/952,170

(22) Filed: Nov. 19, 2024

Related U.S. Application Data
(60) Provisional application No. 63/607,888, filed on Dec. 8, 2023.

(51) Int. Cl. H01M 50/293; H01M 10/658; H01M 50/242; H01M 50/249

(52) U.S. Cl. CPC H01M 50/293; H01M 10/658; H01M 50/242; H01M 50/249

(57) ABSTRACT

A traction battery pack assembly includes a first battery cell, a second battery cell, and a thermal barrier having a divider section and a covering section. The divider section is sandwiched between the first battery cell and the second battery cell along a cell stack axis. The covering section extends axially over the first battery cell and the second battery cell. The covering section includes a first protrusion that contacts a first fold of the first battery cell.

### CROSS-REFERENCE TO RELATED APPLICATIONS

This disclosure claims priority to U.S. Provisional Application No. 63/607,888, which was filed on Dec. 8, 2023, and is incorporated herein by reference in its entirety.

### TECHNICAL FIELD

This disclosure relates generally to thermal barriers of a battery pack and, more particularly, to thermal barriers that can hold a battery cell fold in a folded position.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a traction battery pack assembly, including: a first battery cell; a second battery cell; and a thermal barrier having a divider section and a covering section, the divider section sandwiched between the first battery cell and the second battery cell along a cell stack axis, the covering section extending axially over the first battery cell and the second battery cell, the covering section including a first protrusion that contacts a first fold of the first battery cell.

In some aspects, the techniques described herein relate to a traction battery pack assembly, wherein the first battery cell is a first pouch-style battery cell, and the second battery cell is a second pouch-style battery cell.

In some aspects, the techniques described herein relate to a traction battery pack assembly, wherein the first protrusion holds the first fold in a folded position.

In some aspects, the techniques described herein relate to a traction battery pack assembly, wherein the first protrusion holds the first fold against a body portion of the first battery cell.

In some aspects, the techniques described herein relate to a traction battery pack assembly, wherein the first fold is folded against a folded side of the first battery cell.

In some aspects, the techniques described herein relate to a traction battery pack assembly, wherein the first fold extends along a vertically upward facing side of the first battery cell.

In some aspects, the techniques described herein relate to a traction battery pack assembly, wherein the covering section including a second protrusion that contacts a second fold of the second battery cell.

In some aspects, the techniques described herein relate to a traction battery pack assembly, wherein, along the cell stack axis, the divider section is between the first protrusion and the second protrusion.

In some aspects, the techniques described herein relate to a traction battery pack assembly, wherein the first protrusion and the second protrusion each extend downward from other portions of the covering section.

In some aspects, the techniques described herein relate to a traction battery pack assembly, wherein the covering section of the thermal barrier extends axially from the divider section in a first direction to overhang the first battery cell, and the covering section extends axially from the divider section in an opposite, second direction to overhang the second battery cell.

In some aspects, the techniques described herein relate to a traction battery pack assembly, wherein the thermal barrier is a first thermal barrier, wherein the covering section of the first thermal barrier extends in the first direction to axially overlap with a covering section of a second thermal barrier, and the covering section of the first thermal barrier extends in the second direction to axially overlap with a covering section of a third thermal barrier.

In some aspects, the techniques described herein relate to a traction battery pack assembly, wherein the covering section of the first thermal barrier axially overlaps with the second thermal barrier through a shiplap interface.

In some aspects, the techniques described herein relate to a traction battery pack assembly, wherein the covering section of the first thermal barrier axially overlaps with the second thermal barrier through a tongue and groove interface.

In some aspects, the techniques described herein relate to a traction battery pack assembly, wherein the first thermal barrier, the second thermal barrier, and the third thermal barrier each have a T-shaped cross-sectional profile.

In some aspects, the techniques described herein relate to a traction battery pack assembly, wherein the first protrusion is on a first side of the covering section, wherein an opposite, second side of the covering section includes a channel, wherein an adhesive held within the channel bonds the covering section to an enclosure structure.

In some aspects, the techniques described herein relate to a traction battery pack assembly, wherein the enclosure structure is an enclosure cover.

In some aspects, the techniques described herein relate to a traction battery pack assembly, including: first and second thermal barriers each having a T-shaped cross-section with a stem section and a T-top section; and one or more battery cells sandwiched between the stem section of the first thermal barrier and the stem section of the second thermal barrier along a cell stack axis, the T-top section of the first thermal barrier extending axially over at least a portion of the one or more battery cells in a first axial direction, the T-top section of the second thermal barrier extending axially over at least a portion of the one or more battery cells in a second axial direction and interfacing with the T-top section of the first thermal barrier, the T-top sections, the one or more battery cells each having a fold that is held in a folded position by the first or the second thermal barrier.

In some aspects, the techniques described herein relate to a traction battery pack assembly, wherein the one or more battery cells are pouch-style battery cells.

In some aspects, the techniques described herein relate to a traction battery pack assembly, wherein the T-top section includes one or more protrusions that each directly contacts the fold of one of the one or more battery cells.

In some aspects, the techniques described herein relate to a traction battery pack assembly, wherein the T-top section is adhesively secured to an enclosure structure.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates a perspective view of a battery pack from the electrified vehicle of FIG. 1.

FIG. 3 illustrates a view of an outer case and an electrode being assembled to provide a battery cell for the battery pack of FIG. 2.

FIG. 4 illustrates the battery cell of FIG. 3 after assembly where the outer case as been folded over the electrode and sealed.

FIG. 5 illustrates a portion of a section view taken at line 5-5 in FIG. 2 and showing a portion of a cell stack of the battery pack within an enclosure of the battery pack.

FIG. 6 is a close-up view of an area of FIG. 5.

FIG. 7 is a close-up view of an area of FIG. 6.

FIG. 8 is a perspective view of a thermal barrier from the cell stack of FIG. 5.

### DETAILED DESCRIPTION

Battery cells of the battery pack can discharge vent byproducts during a thermal event. Such battery cells can be pouch cells having folds.

This disclosure details exemplary traction battery packs having thermal barriers that can help hold a fold of a battery cell in a folded position. Holding the fold in a folded position can help to block vent byproducts from being discharged through the side having the fold. Holding the fold can facilitate discharging the vent byproducts from the battery cell through another area. Holding the fold to prevent unfolding is also useful when the battery cells swell over time during ordinary operation.

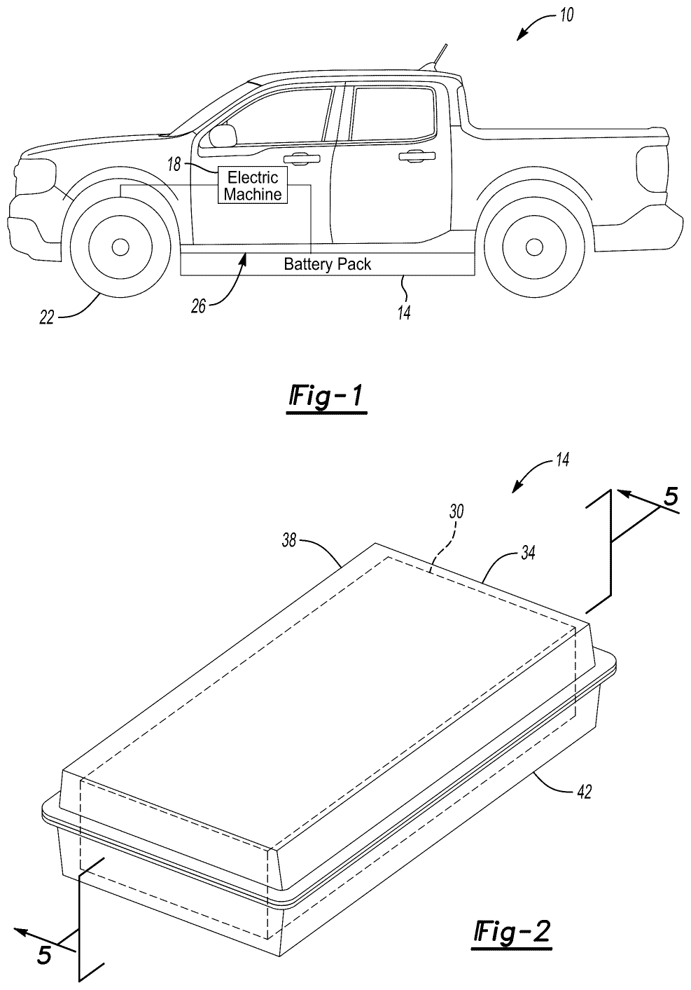

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

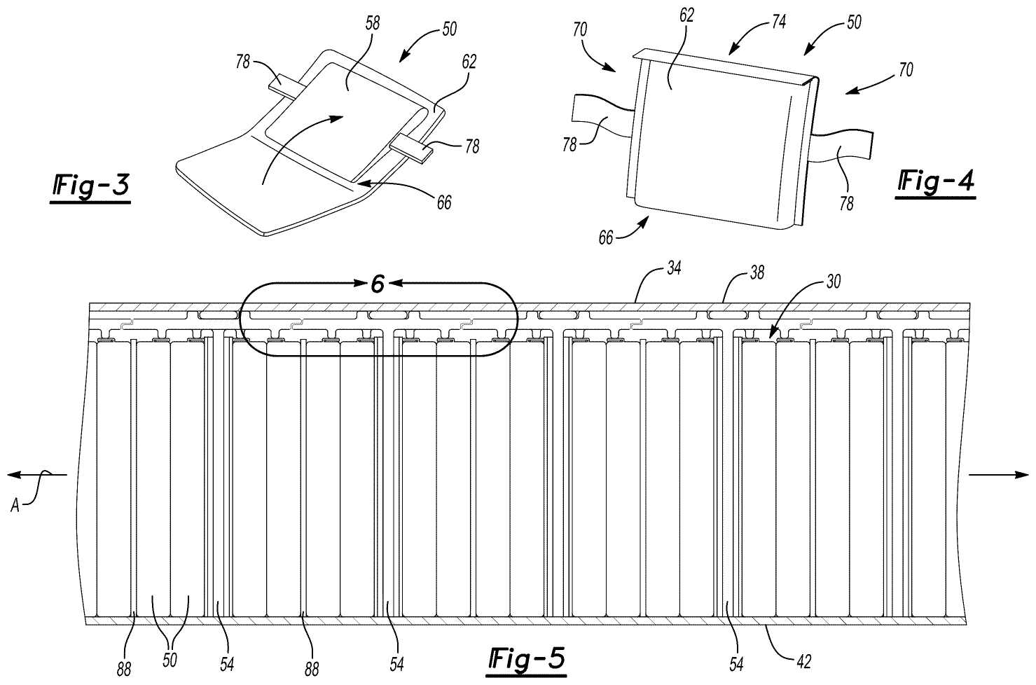

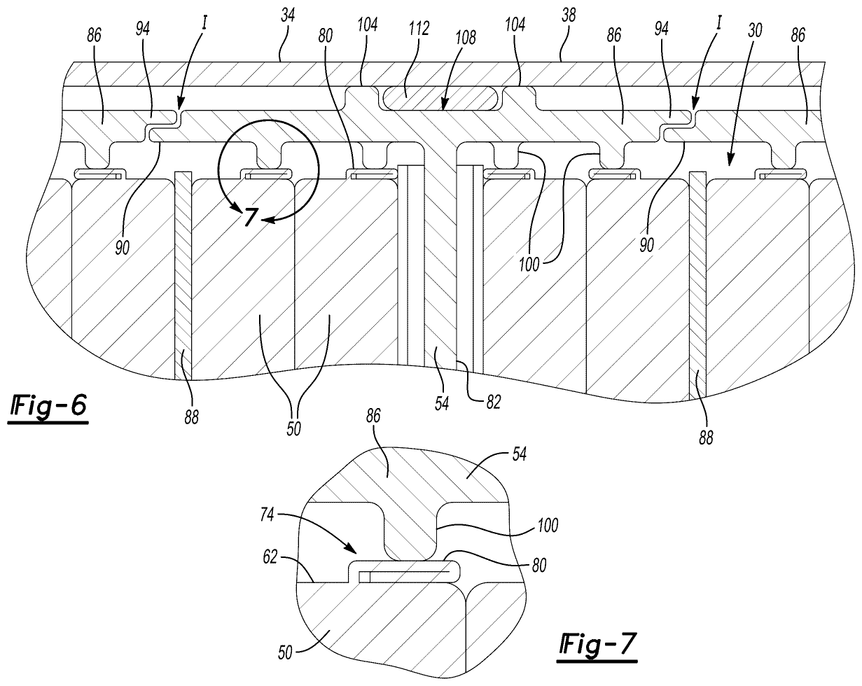

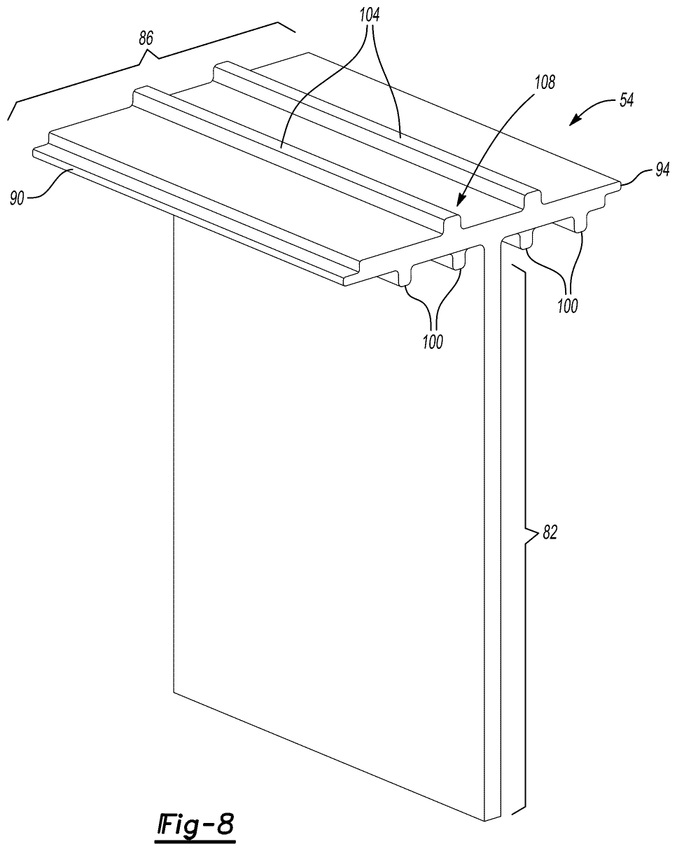

With reference now to FIG. 2-8, the battery pack 14 includes at least one cell stack 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area that houses the cell stack 30. The enclosure cover 38 can be secured to the enclosure tray 42 using mechanical fasteners (not shown), for example.

Each of the cell stacks 30 includes, among other things, a plurality of battery cells 50 (or simply “cells”) and one or more thermal barriers 54 disposed along a respective cell stack axis A. The battery cells 50 store and supply electrical power. Although one cell stack 30 and its cells 50 are illustrated in the various figures of this disclosure, the battery pack 14 could include any number of the cell stacks 30 each having any number of individual cells 50.

In an embodiment, the battery cells 50 are lithium-ion pouch-style cells. However, battery cells having other geometries (cylindrical, prismatic, etc.), other chemistries (nickel metal hydride, lead acid, etc.), or both could be alternatively utilized within the scope of this disclosure.

The examples cells 50 each include an electrode structure 58 held within an outer case 62. The outer case 62 is closed over the electrode structure 58 about a hinged side 66. The outer case 62 is then sealed along seamed sides. In this example, the seamed sides includes two opposing sides 70 and a folded side 74 that is opposite the hinged side 66. Joining the two halves of the outer case 62 along the three seamed sides encloses the electrode structure 58 within the outer case 62. The seamed sides can be considered to extend from a body portion of the battery cell 50, which is the portion of the battery cell 50 containing the electrode structure 58.

Within the cell stack 30, the individual battery cells 50 can be electrically connected together. The cell stacks 30 can also be connected to each other. To facilitate these electrical connections, the battery cells 50 each include a pair of tab terminals 78 extending outward from the electrode structure 58 through the sides 70, which are laterally outer sides of the battery cells 50 in this example. The tab terminals 78 are typically thin strips of foil. The electrode structure 58 can electrically connect to busbars, for example, through the tab terminals 78.

Along the folded side 74, the sealed areas of the example outer case 62 are folded and established a fold 80. In this example, the fold 80 includes the sealed portions along the folded side 74 that are folded in half and then folded again toward the electrode structure 58. The folded side 74 can resist venting of vent byproducts through the folded side 74. Instead, the vent byproducts are directed out through one or both of the sides 70, which are not folded. The folded side 74 is a vertically upward facing side of the battery cells 50 in this example, and the fold 80 extends along the folded side 74. Vertical and horizontal, for purposes of this disclosure are with reference to ground and a general orientation of the battery pack 14 when installed within the electrified vehicle 10.

Within the cell stack 30, the battery cells 50 are arranged in groups, which are separated from each other along the cell stack axis A by the thermal barriers 54. The thermal barriers 54 each have a divider section 82 and a covering section 86. In this examples, the cell stack 30 includes other dividers 88 that do not include covering sections. The dividers 88 without covering sections could be multi-layered structures including a mica layer sandwiched between foam layers.

The divider sections 82 of the thermal barriers 54 are vertically aligned and are the portions of the thermal barriers 54 that are between the battery cells 50 along the cell stack axis A. The groups of battery cells 50 are sandwiched along the cell stack axis A between the divider sections 82 of two thermal barriers 54.

The covering sections 86 extend horizontally from a vertical upper portion of the divider sections 82, which gives the thermal barriers 54 a T-shaped cross-sectional profile. The covering sections 86 can be considered to provide a T-top section of the T-shape and the divider sections 82 a stem section of the T-shape.

The covering sections 86 can extend horizontally toward the covering section 86 of an axially adjacent thermal barrier 54. The covering sections 86 of axially adjacent thermal barriers 54 meet at interfaces I. The covering sections 86 overhang the battery cells 50 of the cell stack 30.

The thermal barriers 54 can help to compartmentalize the interior area. If, for example, one of the battery cells 50 undergoes a thermal event and begins to discharge vent byproducts, the vent byproducts can be contained near the group having the battery cell 50 that is venting. The thermal barriers 54 block the vent byproducts from moving axially adjacent to another groups of battery cells 50. Movement of the vent byproducts along the cell stack axis A toward other battery cells 50 that are not venting can increase thermal energy levels in those battery cells 50 and can potentially lead the thermal event cascading to those battery cells 50. Due to the covering sections 86, the vent byproducts can be blocked from flowing directly against an underside of the enclosure cover 38.

Again, the thermal barriers 54 can block vent byproducts from moving along the cell stack axis A to a position adjacent another group of battery cells 50. The thermal barriers 54—and in particular the covering sections 86—block vent by products that have moved through the interface I between covering sections 86 from moving vertically downward toward another groups of battery cells 50.

In this example, at each interface I, the covering section 86 of one thermal barrier 54 axially overlaps with the covering section 86 of the thermal barrier 54. That is, the covering section 86 of a first one of the thermal barriers 54 extends axially in a first direction over one of the groups, and the covering section 86 of a second one of the thermal barriers 54 extends axially in an opposite, second direction to at least partially axially overlap with a portion of the covering section 86 of the first one of the thermal barriers 54. In this example, the axial overlap is vertical overlap.

In particular, in this example, at each interface I, one thermal barrier 54 includes a lower lip 90 that extends vertically beneath an upper lip 94 of the axially adjacent thermal barrier 54. This interface I can be considered a shiplap interface. In another example, the interface I can be a tongue and groove interface where the covering section 86 of one of the thermal barriers 54 fits within a groove provide by the covering section 86 of another of the thermal barriers 54. The overlap provided by the shiplap interface and the tongue and groove interface are vertical overlaps.

To further facilitate management of the vent byproducts the covering sections 86 include one or more protrusions 100 that extend toward the battery cells 50 from respective undersides of the covering sections 86. In this example, the protrusions 100 extend downward to the battery cells 50. The protrusions 100 can be longitudinally extending ribs. In this example, at least one protrusion 100 is on a first axial side of the divider section 82, and at least one protrusion 100 is on an opposite, second axial side of the divider section 82. The divider section 82 is thus axially between one or more protrusions 100.

In this example, the protrusions 100 extend longitudinally in a direction that is perpendicular to the cell stack axis A. Each of the protrusions 100 is disposed above one of the battery cells 50. The protrusions 100 extend to contact the respective folds 80 of the battery cells 50. The protrusions 100 can each press one of the folds 80 into the body portion of the respective battery cell 50. In this example, the protrusions 100 directly contact the folds 80.

The pressing of the protrusions 100 against the folds 80 helps to maintain the folded sides 74 in a folded state, which can encourage vent byproducts V to exit the battery cells through one or both or the sides 70 rather than through the folded side 74.

In this example, the covering sections 86 include, on their vertically upper side, protrusions 104 that extend upward. The example protrusions 104 are placed adjacent one another to provide a channel 108. Adhesive 112 can be placed within the channel 108 and used to secure the covering sections 86 to an underside of the enclosure cover 34. The protrusions 104 can maintain an appropriate spacing between the enclosure cover 32 and the covering sections 86, and can help to contain the adhesive 112 as it cures to bond the thermal barriers 54 to the enclosure cover 34.

Features of the disclosed examples can include using a thermal barrier to hold a fold of a battery cell in a folded position. The fold can be held folded when the cell expands over time. The fold can be held folded when the cell undergoes a thermal event. The thermal barrier can also hold the battery cell and inhibit vibration and movement of the battery cell so that, among other things, the battery cell remains in contact with a thermal interface material along a bottom of the battery cell.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a first battery cell;
a second battery cell; and
a thermal barrier having a divider section and a covering section, the divider section sandwiched between the first battery cell and the second battery cell along a cell stack axis, the covering section extending axially over the first battery cell and the second battery cell, the covering section including a first protrusion that contacts a first fold of the first battery cell.

2. The traction battery pack assembly of claim 1, wherein the first battery cell is a first pouch-style battery cell, and the second battery cell is a second pouch-style battery cell.

3. The traction battery pack assembly of claim 1, wherein the first protrusion holds the first fold in a folded position.

4. The traction battery pack assembly of claim 1, wherein the first protrusion holds the first fold against a body portion of the first battery cell.

5. The traction battery pack assembly of claim 1, wherein the first fold is folded against a folded side of the first battery cell.

6. The traction battery pack assembly of claim 1, wherein the first fold extends along a vertically upward facing side of the first battery cell.

7. The traction battery pack assembly of claim 1, wherein the covering section including a second protrusion that contacts a second fold of the second battery cell.

8. The traction battery pack assembly of claim 7, wherein, along the cell stack axis, the divider section is between the first protrusion and the second protrusion.

9. The traction battery pack assembly of claim 7, wherein the first protrusion and the second protrusion each extend downward from other portions of the covering section.

10. The traction battery pack assembly of claim 7, wherein the covering section of the thermal barrier extends axially from the divider section in a first direction to overhang the first battery cell, and the covering section extends axially from the divider section in an opposite, second direction to overhang the second battery cell.

11. The traction battery pack assembly of claim 10, wherein the thermal barrier is a first thermal barrier, wherein the covering section of the first thermal barrier extends in the first direction to axially overlap with a covering section of a second thermal barrier, and the covering section of the first thermal barrier extends in the second direction to axially overlap with a covering section of a third thermal barrier.

12. The traction battery pack assembly of claim 11, wherein the covering section of the first thermal barrier axially overlaps with the second thermal barrier through a shiplap interface.

13. The traction battery pack assembly of claim 11, wherein the covering section of the first thermal barrier axially overlaps with the second thermal barrier through a tongue and groove interface.

14. The traction battery pack assembly of claim 11, wherein the first thermal barrier, the second thermal barrier, and the third thermal barrier each have a T-shaped cross-sectional profile.

15. The traction battery pack assembly of claim 1, wherein the first protrusion is on a first side of the covering section, wherein an opposite, second side of the covering section includes a channel, wherein an adhesive held within the channel bonds the covering section to an enclosure structure.

16. The traction battery pack assembly of claim 15, wherein the enclosure structure is an enclosure cover.

17. A traction battery pack assembly, comprising:
first and second thermal barriers each having a T-shaped cross-section with a stem section and a T-top section; and
one or more battery cells sandwiched between the stem section of the first thermal barrier and the stem section of the second thermal barrier along a cell stack axis, the T-top section of the first thermal barrier extending axially over at least a portion of the one or more battery cells in a first axial direction, the T-top section of the second thermal barrier extending axially over at least a portion of the one or more battery cells in a second axial direction and interfacing with the T-top section of the first thermal barrier, the T-top sections, the one or more battery cells each having a fold that is held in a folded position by the first or the second thermal barrier.

18. The traction battery pack assembly of claim 17, wherein the one or more battery cells are pouch-style battery cells.

19. The traction battery pack assembly of claim 17, wherein the T-top section includes one or more protrusions that each directly contacts the fold of one of the one or more battery cells.

20. The traction battery pack assembly of claim 17, wherein the T-top section is adhesively secured to an enclosure structure.
